(19) United States
(12) Patent Application Publication
(10) Pub. No.: US 2008/0296375 A1
(43) Pub. Date: Dec. 4, 2008

(54) Method for assigning voter identifications in a vote by mail system

(75) Inventors: Bertrand Haas, New Haven, CT (US); Matthew J. Campagna, Ridgefield, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/809,569

(22) Filed: Jun. 1, 2007

(51) Int. Cl. G07C 13/00

(52) U.S. Cl. 235/386; 705/12

(57) ABSTRACT

A method of conducting an election including storing a signature image for each voter, providing a plurality of return envelopes, providing an indicium having a barcode on each of the return envelopes, for each of the return envelopes, associating the barcode of the indicium with a respective one of the voters, and mailing each return envelope and a ballot to the voter with which the barcode data of the indicium of the envelope has been associated. When each return envelope including a completed ballot and a written signature thereon is received, the method includes obtaining from the return envelope the written signature and the barcode of the indicium provided thereon, using the obtained barcode to access the stored authorized signature image of the voter with which the barcode is associated, and comparing the obtained written signature to the authorized signature in the accessed image.

### FIELD OF THE INVENTION

The present invention relates to voting systems, and in particular to a method of assigning voter identifications which are used to identify and access stored signatures for the voters in a vote by mail system.

### BACKGROUND OF THE INVENTION

In democratic countries, governmental officials are chosen by the citizens in an election. Conducting an election and voting for candidates for public office in the United States can be performed in several different ways. One such way utilizes mechanical voting machines at predetermined polling places. When potential voters enter the predetermined polling place, voting personnel verify that each voter is properly registered in that voting district and that they have not already voted in that election. Thus, for a voter to cast his vote, he must go to the polling place at which he is registered, based on the voter's residence. Another method for conducting an election and voting utilizes paper ballots that are mailed to the voter who marks the ballot and returns the ballot through the mail. In a vote by mail system, the voter marks the ballot to cast his/her vote and then inserts the ballot in a return envelope which is typically pre-addressed to the voter registrar office of the voting authority in the corresponding county, town or locality in which the voter is registered. The voter also typically appends his/her signature on the back of the return envelope adjacent his/her human or machine readable identification. When the return envelope is received at the registrar's office, the voter's signature on the envelope is compared with a copy of the voter's signature that is retrieved from a registration file to make a determination as to whether or not the identification information and signature are authentic and valid, and therefore that the vote or votes on the ballot included in the return envelope should be counted.

In many current vote by mail systems, the copies of the voters' signatures are stored electronically as an image in a database maintained by the voting authority. In such systems, voters are assigned an identification (typically a unique identification number) which is mainly used as an identifier of the stored image of the voter's signature. Each voter's identification is printed, typically in the form of a barcode, on the back of the return envelope, together with the voter's name and address. As noted above, before sending the completed ballot back, the voter signs the back of the return envelope. Upon receipt of the return envelope, the voting authority scans the identification provided on the return envelope (e.g., scans the barcode), uses the scanned identification to obtain the image of the voter's signature from the database, and compares the signature on the envelope to the stored signature to determine whether the vote is authentic and should be counted.

For security reasons, the name and address of a voter should not appear on the return envelope in a manner that would allow it to be readily seen so that no one is able to monitor who is actually voting, as such monitoring could be used to divert ballots from voters known or suspected to vote for particular candidates. However, it is beneficial to provide the name and address of the voter on the return envelope as a means to enable the voter to make sure that he or she is inserting their ballot in the correct return envelope, i.e., the one assigned to them specifically and therefore linked to their signature as described above, as opposed to the return envelope of another voter such as the voter's spouse or neighbor. Thus, most current return envelopes provide a mechanism for hiding the voter's name and address, such as by having it covered by the envelope flap after it is sealed. In addition, for security reasons, the voter's signature should also be hidden once it is applied to the return envelope, and a number of methods have been developed for doing so, including those that hide the signature under certain conditions, but allow the signature to be viewed and therefore scanned under other conditions. In one such method, the signature is covered by a window made out of a film (which is typically expensive) that is opaque under normal conditions and transparent under certain other physical conditions, such as specific illumination or temperature.

Notwithstanding the security procedures just described, the voter identification that is used to retrieve the stored image of the voter's signature is often printed in plain sight on the return envelope without any measures to hide it. A false sense of security is created due to the fact that the voter identification is typically provided only in a machine readable form. This, however, could be problematic. For example, if someone learned the identifications of a voter or groups of voters (for instance as a result of a leak of the voting authority's database), that individual could monitor the mail for ballots from those people (such a person could employ a suitable bar code reader) and divert them (for instance, an attacker could use a barcode reader and cause a return envelope to be diverted when the identification of an “undesirable” voter is read). Steps could be taken to hide the identification in a manner similar to the way in which signatures are hidden as described above, but such steps are likely to add to the cost of the return envelope (e.g., the window used to obscure the signature would need to be made larger to accommodate the identification as well as the signature, which would add to cost). In addition, steps could be taken to vary the identifications for each election so that each voter will have a different identification in each election, therefore making it less likely that the identifications could be compromised. However, such a system would impose the extra task of generating new identifications in a collision free manner at each election. Finally, with or without added security, printing the identifications on the return envelopes requires ink that also adds to the cost of the return envelope. Thus, there is a need for a method of assigning voter identifications in a vote by mail system that addresses these problems.

### SUMMARY OF THE INVENTION

The present invention provides a method of conducting a vote by mail election wherein completed ballots are received from a plurality of voters. The method includes storing an image of an authorized signature of each of the voters, providing a plurality of return envelopes, and providing a postal indicium having a barcode on each of the return envelopes. The method further includes, for each of the return envelopes, associating the barcode of the postal indicium of the return envelope with a respective one of the voters, and mailing each return envelope and a ballot to the voter with which the barcode of the postal indicium of the return envelope has been associated. When each return envelope including a completed ballot and a written signature provided thereon is received, the method includes obtaining from the return envelope the written signature and the barcode of the postal indicium provided thereon, using the obtained barcode to access the stored image of the authorized signature of the voter with which the barcode is associated, and comparing the obtained written signature to the authorized signature in the accessed stored image. Preferably, the completed ballot of each received return envelope is counted in the election only if the comparing step determines that the obtained written signature matches the authorized signature in the accessed stored image.

In the preferred embodiment, the postal indicium is a digital postage mark and the barcode of each digital postage mark is a two-dimensional barcode. Also in the preferred embodiment, the barcode of each postal indicium is associated with one of the voters in a database. In addition, the image of the signature of each of the voters is also preferably stored in the database in association with the voter.

In one particular embodiment, the step of obtaining from the return envelope the written signature comprises reading the written signature through a window of the return envelope under a first set of one or more conditions, wherein the window is substantially opaque and obscures the written signature under a second set of one or more conditions.

In another particular embodiment, the step of mailing each return envelope and a ballot comprises mailing each return envelope and a ballot in an outgoing envelope, wherein prior to the mailing step, the method comprises printing the name and address of the voter with which the barcode of the postal indicium of the return envelope has been associated. The step of printing the name and address may include printing the name and address onto the return envelope through a window provided in the associated outgoing envelope. Also, the steps of obtaining from the return envelope the written signature and the barcode of the postal indicium provided thereon may include reading and decoding the barcode of the postal indicium using a barcode reader.

In still another particular embodiment, in the mailing step, the postal indicium provided on each return envelope is used as evidence of postage payment. Alternatively, the step of mailing each return envelope and a ballot may include mailing each return envelope and a ballot in an outgoing envelope having evidence of postage payment that is separate from the postal indicium provided on the return envelope.

For each of the return envelopes, the step of associating the barcode of the postal indicium of the return envelope with a respective one of the voters may include reading the postal indicium to obtain the barcode and storing the obtained barcode in a database in association with the respective one of the voters.

The step of providing a postal indicium on each of the return envelopes may be performed for all of the return envelopes prior to associating the barcode with a voter for any of the return envelopes. Alternatively, each postal indicium may be generated for each return envelope (and thus provided for the return envelope) at the time that the return envelope is provided with the address of the associated voter.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIGS. 1 and 2 are back and front views, respectively, of one embodiment of a return envelope that may be employed in the present invention for returning a ballot to the voting authority after it is completed by a voter;

FIGS. 3-8 illustrate how the return envelope shown in FIGS. 1 and 2 and a ballot are mailed to the voter using an outgoing envelope according to an embodiment of the invention;

FIG. 9 is a flowchart illustrating a method of mailing ballots to a plurality of voters in an election according to one embodiment of the present invention wherein each voter is assigned a voter identification based on the postal indicium, preferably a digital postage mark, provided on the return envelope; and

FIG. 10 is a flowchart of a method of verifying the signature of a voter provided on a return envelope that is returned to the voting authority after the voter has recorded his or her votes on a ballot according an embodiment of the present invention.

### DESCRIPTION OF THE PREFERRED EMBODIMENTS

The postal services of many countries around the world permit and/or require the printing of postal indicia that include two dimensional barcodes. Such indicia are commonly referred to as Digital Postage Marks (DPM). DPMs typically may include a number of information items in human readable and/or machine readable form, such as, and without limitation, the paid postage amount, the date and time the indicium was generated, the identification number and the ascending register value of the postage meter used to generate the indicium, a postal service symbol, and the class of service desired for the mailpiece. For example, the United States Postal Service has implemented a program known as the Information Based Indicia Program (IBIP) which permits a user to generate a postal indicium for sending a mailpiece (e.g., letter, package, etc.) that includes a human readable portion and a machine readable portion in the form of a two dimensional barcode, such as, without limitation, a Data Matrix symbol. The two dimensional barcodes employed in many DPMs, such as the Data Matrix symbol in an IBIP indicium, also include encrypted information, such as the postage amount and other postal data relating to the mailpiece and the postage meter that printed the indicium (usually referred to as a digital token or a digital signature), that may be used by the particular postal service in question to authenticate the indicia after the mailpieces have been inserted into the mail stream.

As is known, a two dimensional barcode, such as a Data Matrix symbol, typically consists of a number of data regions having nominally square modules arranged in an array, wherein each module generally represents one bit of data. For a black on white Data Matrix symbol, for instance, a darkened (i.e., filled) module represents a binary “one” and a light (e.g., empty) module represents a binary “zero.” Thus, each two dimensional barcode, such as a Data Matrix symbol, represents a number in binary form (a bit string), and can be read and decoded by a suitable reader device to obtain the number therefrom.

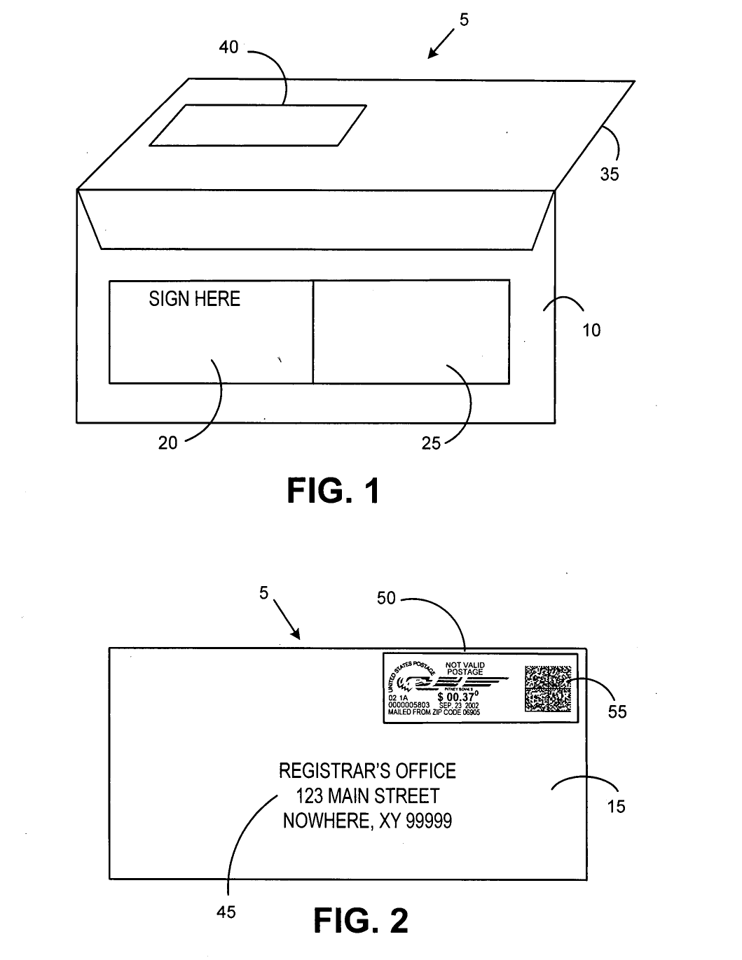

The present invention provides a method for assigning identification numbers to voters in a vote by mail system which employs postal indicia (preferably DPMs) provided on the return envelopes used to return the completed ballots to the voting authority once the voters have entered their votes on the ballots. The uniqueness of each postal indicium ensures that every voter will have a different identification in each election, thereby making it highly unlikely that identifications could be compromised. Additionally the risk of identification collision, i.e., more than one voter having the same identification, if eliminated. FIGS. 1 and 2 are back and front views, respectively, of one embodiment of a return envelope 5 that may be employed in the present invention for returning a ballot 30 (FIG. 4) after it is completed by a voter. The return envelope 5 includes a back face 10 (FIG. 1) and a front face 15 (FIG. 2). The back face 10 has a first portion 20 on which the voter is to sign his or her name after casting his or her vote or votes on the ballot 30 received by the voter and a second portion 25 on which the name and address of the voter receiving the associated ballot 30 are to be printed by the voting authority as described elsewhere herein.

The return envelope 5 further includes a flap 35 which is structured to be folded over the back face 10 of the return envelope 5 after the associated completed ballot 30 has been inserted therein. When the flap 35 is folded over the back face 10, it will cover and obscure from view the name and address that are printed on the portion 25. In addition, the flap 35 includes a window 40 that is structured to cover the signature provided on the first portion 20 of the back face 10 when the flap 35 is folded over the back face 10. The window 40 is made out of a film of material that is opaque under normal viewing conditions, thus hiding the signature from view, and transparent under certain other physical conditions, such as specific illumination or temperature, so that the signature can be viewed by the voting authority for verification purposes as described elsewhere herein.

As seen in FIG. 2, the front face 15 of the return envelope 5 has the return address 45 of the voting authority administering the election in question printed thereon. In addition, the front face 15 has a DPM 50 (prepaid by the voting authority) printed thereon that provides the evidence of postage payment for returning the return envelope 5 and ballot 30 inserted therein to the voting authority. The DPM 50 includes a two-dimensional barcode 55, which may be, for example, a Data Matrix Symbol. As described elsewhere herein, the two dimensional barcode 55 has encoded therein, in binary form (a bit string), certain information items which may include, without limitation, the paid postage amount, the date and time the indicium was generated, the identification number and the ascending register value of the postage meter used to generate the indicium. Because the information included will be unique for every indicium, each postal indicium itself will be unique.

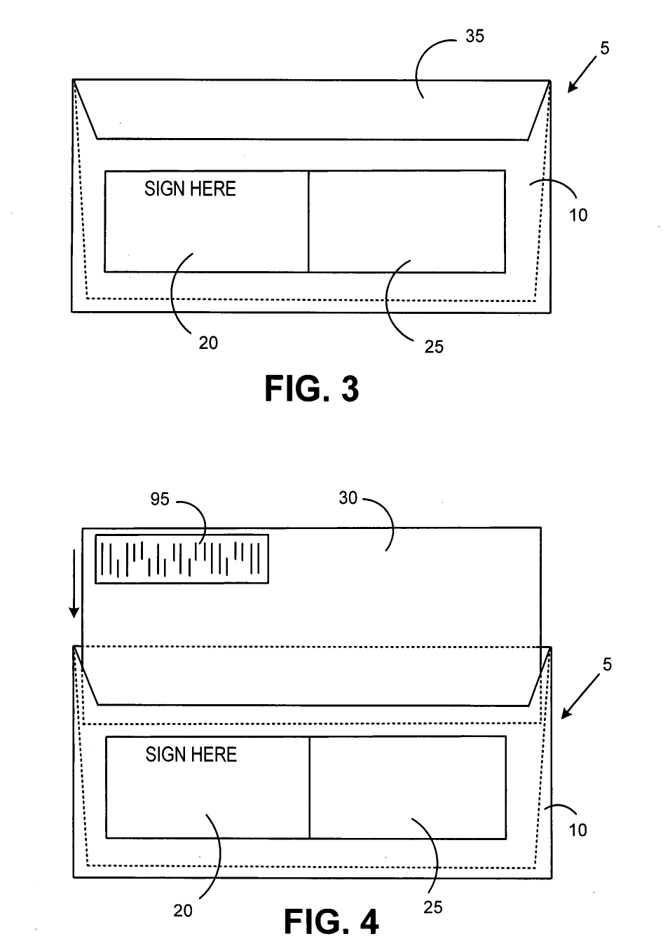

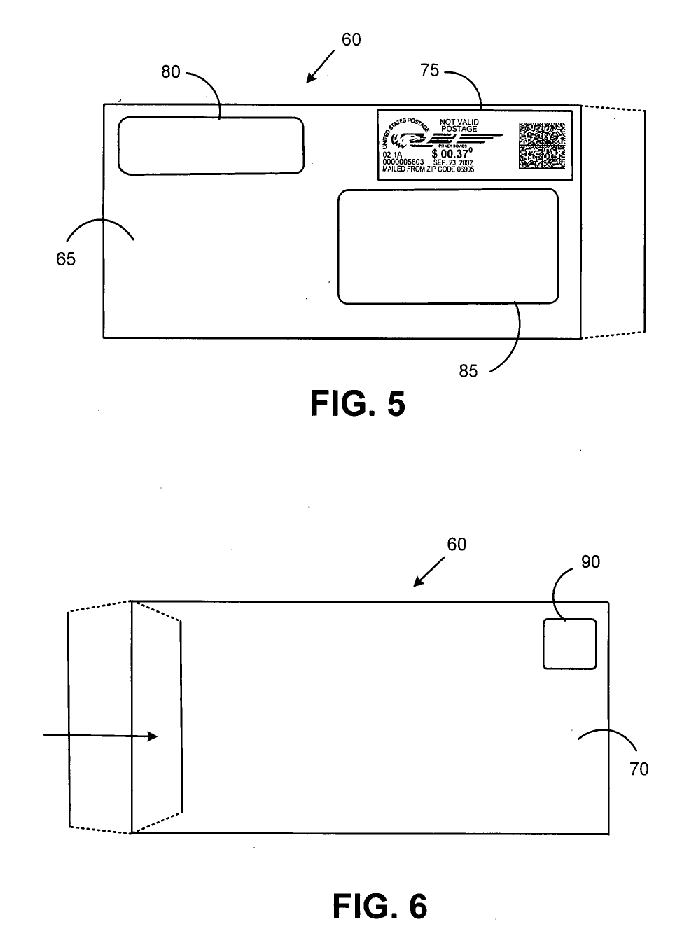

FIGS. 3-8 illustrate how the return envelope 5 and ballot 30 are mailed to the voter. First, the flap 35 is folded inside the return envelope 5 as shown in FIG. 3, or alternatively, the flap 35 is folded in half back on itself. In either of these configurations, the back face 10, and in particular the first portion 20 and the second portion 25 of the back face 10, are exposed (i.e., are not covered). Next, the blank ballot 30 is inserted into the return envelope 5 over the flap 35 as shown in FIG. 4 (see the arrow). FIGS. 5 and 6 are front and back views, respectively, of an outgoing envelope 60 used by the voting authority to mail the return envelope 5 and the blank ballot 30 (FIG. 4) to the appropriate voter. The outgoing envelope 60 includes a front face 65 (FIG. 5) and a back face 70 (FIG. 6). The front face 65 includes a DPM 75 which serves as evidence of postage payment for the mailing of the outgoing envelope 60 and its contents. The front face 65 also has windows 80 and 85 (in the form of openings) provided therein for reasons to be described below. Similarly, the back face 70 has a window 90 (in the form of an opening) provided therein for reasons to be described below.

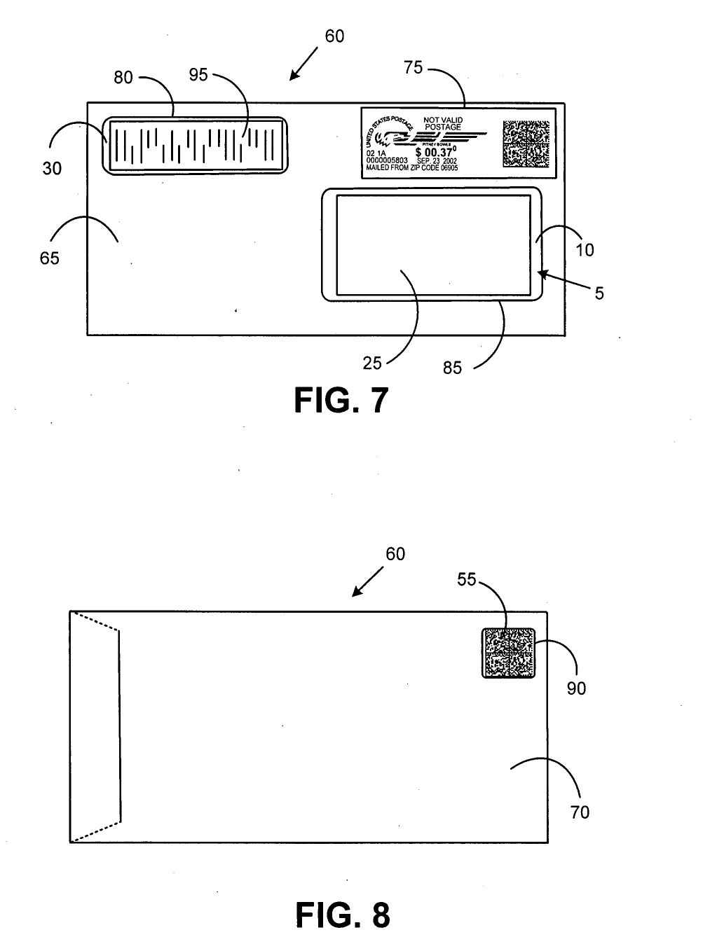

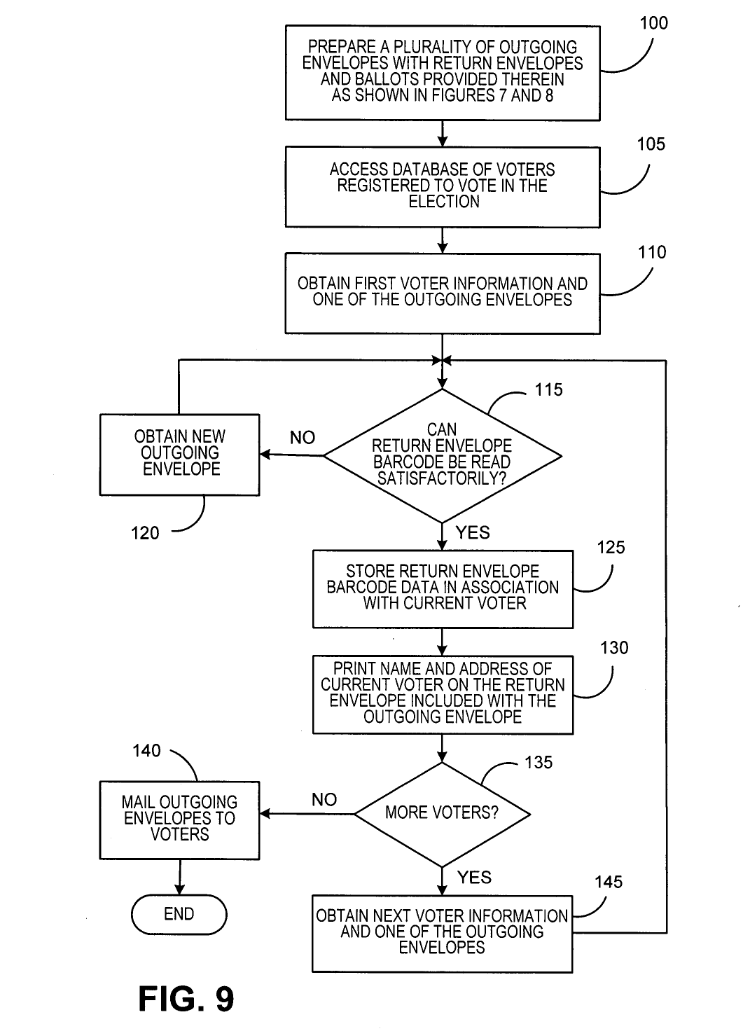

The return envelope 5 and the blank ballot 30 (FIG. 4) are inserted into the outgoing envelope 60 in the direction of the arrow in FIG. 6 with the back face 10 of the return envelope 5 facing in the same direction as the front face 65 of the outgoing envelope 60. Thus, as seen in FIGS. 7 and 8, after the return envelope 5 and the blank ballot 30 are inserted in this manner, the second portion 25 of the back face 10 of the return envelope 5 will be accessible and viewable through the window 85 provided in the front face 65 of the outgoing envelope 60, a ballot type identifier 95 provided on the ballot 30 (which identifies what election the ballot 30 is being used for) will be accessible and viewable through the window 80 provided in the front face 65 of the outgoing envelope 60, and the two-dimensional barcode 55 of the DPM 50 of the return envelope 5 will be accessible and viewable through the window 90 provided in the back face 70 of the outgoing envelope 60. At this point, the outgoing envelope 60 and its contents (the return envelope 5 and ballot 30) are ready to be mailed to the voter according to the method described below which assigns a voter identification to the voter based on the two-dimensional barcode 55 of the DPM 50. The voter identification assigned in this manner is used to identify a particular stored voter signature image for verification purposes as described herein.

FIG. 9 is a flowchart illustrating a method of mailing ballots to a plurality of voters in an election according to one embodiment of the present invention wherein each voter is assigned a voter identification based on the postal indicium, preferably a digital postage mark, provided on the return envelope. For illustrative purposes, the method shown in FIG. 9 will be described in connection with the return envelope 5 shown in FIGS. 1-4, 7 and 8, although it will be appreciated that other return envelope embodiments are possible. In addition, it should be appreciated that the term return envelope is to be interpreted broadly as used herein, and may include embodiments where the envelope resembles a separate traditional envelope, or alternatively embodiments where the envelope is partly generated by the sender by making certain folds in and sealing certain portions of a piece of paper (such embodiments may include an embodiment where the envelope and ballot are integrated and the envelope is created from the ballot after the ballot is completed by making certain folds and sealing certain portions thereof).

Referring to FIG. 9, the method begins at step 100, wherein a plurality of outgoing envelopes 60 with return envelopes 5 and ballots 30 provided therein are prepared by the voting authority. This step will include the generation and printing of the DPM 50 (including the barcode 55) for each return envelope 5 using a suitable postage metering device. Next, at step 105, the voting authority, preferably using a computerized device described below which performs the reading steps, accesses the database of voters that are registered to vote in the election in question. That database will preferably store the voter's name and address and an authorized signature of the voter. Next, at step 110, information for a first voter to receive a ballot is obtained from the database. Also in step 110, one of the outgoing envelopes 60 prepared in step 100 is obtained. Next, at step 115, a determination is made as to whether the two-dimensional barcode 55 on the return envelope 5 that is provided in the outgoing envelope 60 obtained in step 110 can be satisfactorily read by a suitable barcode reader. As will be appreciated, a suitable computerized reader device is employed in step 115 to scan the two-dimensional bar code 55 through the window 90 provided on the back face 70 of the current outgoing envelope 60. If the answer at step 115 is no, then, at step 120, a new outgoing envelope 60 is obtained from the supply of outgoing envelopes 60, and the current, unreadable outgoing envelope 60 is discarded. The method then returns to step 115. However, if the answer at step 115 is yes, meaning that the two-dimensional barcode 55 can be read, then, at step 125, the data encoded in the two-dimensional barcode 55 of the return envelope 5 is stored by the voting authority, preferably in a suitable database, in association with the current voter (i.e., in association with that current voter's name and/or address and authorized signature). Then, at step 130, a suitable printing device is used to print the name and address of the current voter, obtained in step 110, on the second portion 25 of the back face 10 of the current return envelope 5 through the window 85 that is provided in the front face 65 of the current outgoing envelope 60. Next, at step 135, a determination is made as to whether there are more voters in the database (step 105) that need to have outgoing envelopes 60 prepared for them. If the answer is no, then, at step 140, the outgoing envelopes 60 that have been prepared as just described are mailed to the voters and the method ends. If, however, the answer at step 125 is yes, meaning that more voters remain, then, at step 145, the voter information for the next voter is obtained from the database and another one of the outgoing envelopes 60 is obtained from the supply of outgoing envelopes 60. Next, the method returns to step 115 and proceeds as just described. Thus, the method shown in FIG. 9 will result in a plurality of outgoing envelopes 60 having the appropriate voter identification information printed thereon created for mailing to the voters, and will also result in barcode data from each of the return envelopes 5 being associated with the corresponding voter in a database. Once the method shown in FIG. 9 is completed, if a database is employed for associating the barcode data (encoded in the barcode 55) with the corresponding voter (which is preferred), the database may be reordered for search efficiency. For instance, the database can be reordered in lexicographic order of the bit string encoded in each barcode 55 of each DPM 50.

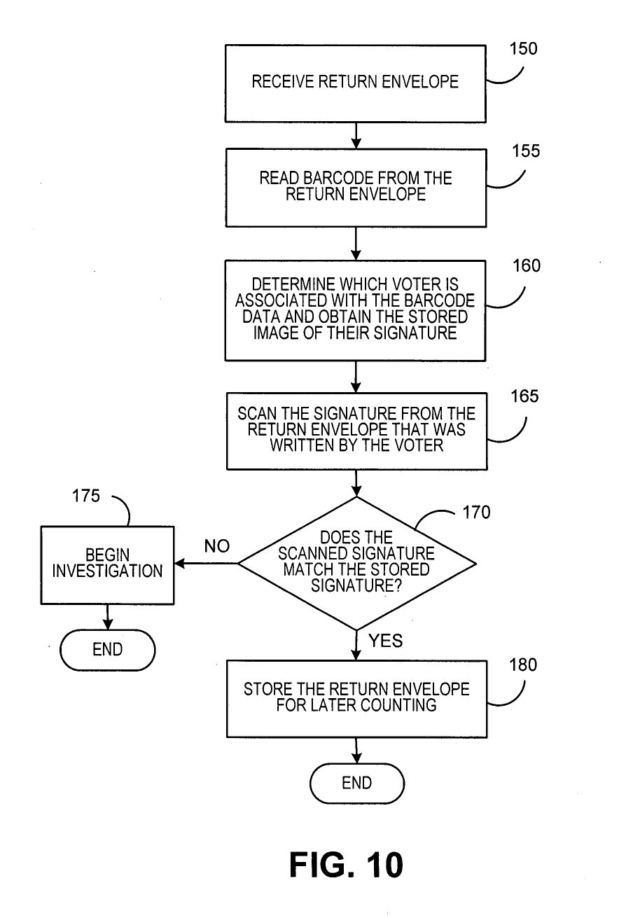

FIG. 10 is a flowchart of a method of verifying the signature of a voter provided on a return envelope 5 that is returned to the voting authority after the voter has recorded his or her votes on a ballot 30. As noted above, after the voter enters his or her votes on the ballot 30, the voter inserts the completed ballot 30 into the return envelope 5. The voter then signs his or her name on the first portion 20 of the back face 10 of the return envelope, and closes and seals the flap 35 of the return envelope 5. As a result, the signature will be obscured (hidden from view) under normal conditions by the window 40, but may be read under certain other conditions, such as through certain illumination and/or temperature being applied to the window 40.

Referring to FIG. 10, the method begins at step 150, wherein a return envelope 5 having a ballot 30 therein is received through the mail by the voting authority. Next, at step 155, the voting authority reads the two-dimensional barcode 55 forming a part of the DPM 50 that is provided on the front face 15 of the return envelope 5. Again, step 155 is preferably performed using a suitable barcode reader which will read and decode the two-dimensional barcode 55, thereby obtaining the barcode data stored therein (i.e., the number in binary form (bit string) represented by the barcode 55). Next, at step 160, the database created/updated in step 125 of FIG. 9 is consulted to determine which voter is associated with the barcode data that was obtained in step 155. In addition, in step 160, the stored image of that voter's authorized signature is also obtained. That stored image may be obtained from a separate database that stores authorized signature images in association with voter names, or, alternatively, those stored images may be stored in the database that includes the barcode data and voter information created in step 125. In other words, step 160 may be performed by consulting a separate database of stored images, or, alternatively, a single database may be maintained that includes the barcode data and stored signature image in association with the voter name.

Next, at step 165, the signature is scanned from the first portion 20 of the back face 10 of the return envelope 5 through the window 40 in an appropriate manner. For example, a particular wavelength of light may be used to illuminate the window 40, thereby making the signature viewable, and an appropriate scanning device may be used to capture an image of the signature that can then be viewed through the window 40. As will be appreciated, other methods of obtaining the signature may be employed. For example, since the return envelope 5 is securely in the possession of the voting authority, the flap 35 could be opened and the signature could then be scanned (in this embodiment, the window 40 would not be necessary and could be replaced by an opaque portion of the flap 35). Next, at step 175, a determination is made as to whether the scanned signature (step 165) matches the stored authorized signature that was obtained in step 160. This may be performed automatically by a suitable computer using comparison software, or, alternatively, may be performed manually. If the answer at step 170 is no, then, at step 175, an investigation is initiated to determine why the signatures do not match. However, if the answer at step 170 is yes, then the return envelope 5 is stored as an acceptable return envelope 5 for subsequent opening and counting of the votes contained on the ballot 30 included within the return envelope 5. Alternatively, rather than storing the return envelope 5 at this point, it may be opened and the votes on the ballot 30 contained therein may be counted at that time.

Thus, the methods shown and FIGS. 9 and 10 provide a way in which dynamic voter identifications can be created for identifying a voter's stored authorized signature image in a particular election and subsequently used to verify the voter's signature appended to a return envelope containing a ballot. As a result, the methods address the shortcomings of the prior art that are described elsewhere herein.

In the embodiment shown in FIG. 9, the DPM 50 of each return envelope 5 is printed during a “packaging” step (step 100) where a number of return envelopes 5 are created for later insertion into an outgoing envelope 60. The barcode 55 of each DPM 50 is later scanned through the window 90 in the corresponding outgoing envelope 60 and thereafter the associated voter's address is printed on the return envelope 5 (steps 115-130 of FIG. 9). In an alternative embodiment, rather than pre-generating a plurality of return envelopes with DPMs 50 prior to the address printing step, the DPM 50 of each return envelope 5 is generated and printed through the window 90 in the corresponding outgoing envelope 60 during the step wherein the associated voter's address is printed. In this embodiment, the barcode data represented by the barcode 55 in each DPM 50 can be directly linked to the associated voter as soon as it is created, thereby eliminating the need to scan the barcode 55 to obtain the data.

In yet another alternative embodiment, a DPM (similar in form to DPM 55) is still used to provide the barcode data that is associated with the voter for later accessing that voter's stored signature image. However, in this embodiment, that DPM is actually used to provide the evidence of postage payment for the outgoing envelope that is used to mail the return envelope to the voter. In this embodiment, the DPM is preferably printed on the return envelope after it is inserted into the outgoing envelope through a window provided in the outgoing envelope at the usual postage position on the outgoing envelope (i.e., the upper right corner on the front). As will be appreciated, the place on the return envelope where the DPM is printed in this embodiment must be different than the usual postage position on the return envelope, as another indicium or other evidence of postage payment (e.g., a stamp) must be provided in the usual postage position of the return envelope so that it can be used to return the completed ballot to the voting authority. The DPM that is used to provide the barcode data that is associated with the voter in this embodiment may or may not be visible on the return envelope when it is ultimately returned to the voting authority. In the latter case, it could be hidden by, for example, a window similar to window 40 provided on a flap of the return envelope and read as described elsewhere herein in connection with the window 40. Once the return envelope containing the completed ballot is received in this embodiment, the method shown in FIG. 10 may be used to verify the voter's signature.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of conducting a vote by mail election for a plurality of voters, comprising:
providing a plurality of return envelopes;
providing a postal indicium on each of said return envelopes, each said postal indicium having a barcode that is associated with a respective one of said voters; and
mailing each return envelope and a ballot to the voter with which the barcode of the postal indicium of the return envelope has been associated.

2. The method according to claim 1, further comprising:
receiving a return envelope including a completed ballot and a written signature provided thereon;
obtaining from the return envelope the written signature and the barcode of the postal indicium provided thereon;
using the obtained barcode to access a stored image of an authorized signature of the voter with which the barcode is associated; and
comparing the obtained written signature to the authorized signature in the accessed stored image.

3. The method according to claim 2, further comprising:
counting the completed ballot of each received return envelope in said election if the obtained written signature matches the authorized signature in the accessed stored image.

4. The method according to claim 2, wherein obtaining from the return envelope the written signature further comprises:
reading said written signature through a window of said return envelope under a first set of one or more conditions, wherein said window is substantially opaque and obscures said written signature under a second set of one or more conditions.

5. The method according to claim 2, wherein obtaining from the return envelope the written signature and the barcode of the postal indicium provided thereon further comprises:
reading and decoding the barcode of the postal indicium using a barcode reader.

6. The method according to claim 1, wherein said return envelope and said ballot are integral with one another.

7. The method according to claim 1, wherein each said postal indicium is a digital postage mark and the barcode of each said digital postage mark is a two-dimensional barcode.

8. The method according to claim 1, wherein the barcode of each said postal indicium is associated with one of said voters in a database.

9. The method according to claim 8, wherein the image of the authorized signature of each of said voters is also stored in said database in association with the voter.

10. The method according to claim 1, wherein mailing each return envelope and a ballot further comprises:
mailing each return envelope and a ballot in an outgoing envelope.

11. The method according to claim 10, wherein prior to mailing each return envelope and a ballot in an outgoing envelope, said method further comprises:
printing on the return envelope the name and address of the voter with which the barcode of the postal indicium of the return envelope has been associated.

12. The method according to claim 1 1, wherein printing on the return envelope the name and address of the voter further comprises:
printing the name and address of the voter with which the barcode of the postal indicium has been associated onto the return envelope through a window provided in the associated outgoing envelope.

13. The method according to claim 10, wherein the postal indicium provided on each said return envelope is used as evidence of postage payment for the outgoing envelope.

14. The method according to claim 1, wherein for each of the return envelopes, providing a postal indicium further comprises:
reading the postal indicium to obtain the barcode; and
storing the obtained barcode in a database in association with the respective one of said voters.

15. The method according to claim 14, wherein mailing each return envelope and a ballot comprises mailing each return envelope and a ballot in an outgoing envelope, and wherein prior to said mailing, said method comprises:
printing onto the return envelope through a window provided in the outgoing envelope the name and address of the voter with which the barcode of the postal indicium of the return envelope has been associated.

16. The method according to claim 1, wherein mailing each return envelope and a ballot further comprises:
mailing each return envelope and a ballot in an outgoing envelope having evidence of postage payment that is separate from the postal indicium provided on the return envelope.
